(19) United States
(12) Patent Application Publication
(10) Pub. No.: US 2009/0211250 A1
(43) Pub. Date: Aug. 27, 2009

(54) Method and device for waste disposal

(75) Inventor: Ronald Orawetz, Weilheim (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Uta Orawetz, Weilheim (DE)

(21) Appl. No.: 11/911,553

(22) PCT Filed: Apr. 10, 2006
(86) PCT No.: PCT/DE06/00632

§ 371 Date: Sep. 19, 2008

(30) Foreign Application Priority Data
Apr. 14, 2005 (DE) 10 2005 017 334.9

(51) Int. Cl. F01K 13/00; B03B 9/06

(52) U.S. Cl. 60/645; 60/643

(57) ABSTRACT

Disclosed are a waste disposal method and device having the following characteristics: a) a water basin (2, 2a, 2b, 2c) for separating metal components; b) a water basin (3) for separating plastic components and minerals; c) mills (3b, 3d) for processing the plastic components into granulate; d) a mill (4) for comminuting the remaining waste; e) a drying stage (5) for drying the remaining waste; f) a stage (6) for removing ashes from the dried waste; g) a mixing stage (7) for mixing the ash-free waste with plastic granulate and sewage sludge at an adjustable ratio; a press (8) for shaping the mixed product into pellets; i) a stage for burning (9) the pellets in order to generate power.

In earlier times, the term waste was used religiously or politically. In an encyclopedia printed in 1732 the term “waste” was defined as disloyalty of anyone against an individual he/she is obliged to”. That is, waste can be directed to god and to people.

Later on, due to a shortage of raw materials and fertilizers, wastes were esteemed to be very valuable starting materials.

In the time of high-productive industrializing at the end of the 19^{th} century, for the first, wastes were regarded as unwanted raw materials. Wastes ranked with the by-products which were very troublesome for factories.

Since the beginning of the 20^{th} century, the term waste has included residual materials such as waste water and refuse attributed to the increasing urbanization, in addition to residual industrial material. Initially, waste was disposed by means of relatively simple methods. Waste was deposited on remote places not used for other purposes (see Meyer's encyclopedia published in 1924).

According to Duden, the actual definition reads: “Residues remaining with the production or preparation of anything, which are not used for other purposes and are thrown away”. This definition results from the immense increase of transportation of materials and goods and the complex compositions thereof after world war II. At that time, there was the need to dispose waste to a great extent. However, in the seventies and the eighties of the last century, it was recognized that a non-arranged waste disposal can lead to massive damages to the environment and to injuries to health and that waste disposal has to be controlled unconditionally.

Now, in the age of sustainability, novel and comprehensive ways of thinking gain in importance. Future guide-lines for waste disposal must include the ecological standards hitherto existing and help to improve them, but also provide framework conditions
a) for an optimum and efficient economical waste management,
b) for liberalizing of waste management as far as possible,
(c) for an improved sharing of duties between government, federal states and communities,
(d) for streamlining of waste disposal to citizens, industry and trade,
(e) by means of which future waste management can be integrated in a superior sustainable resource policy and impulses can be given for realizing it.

Waste management, like management in many other fields, offers a great potential for making it optimum and effective. However, stable framework conditions have to be provided for corporate bodies, which enable them to utilize such potentials. As waste disposal plants require high investments in capital, they can be amortized ingenious only when being used over a long period.

Many things of daily need get into waste or household refuse. Almost have a ton of such waste accrues per person annually. That means annihilation of raw materials and energy. Almost ⅓ of household waste is organic material and can be composted. Gaining of glass from waste glass requires 25% less energy than the production of new glass. Half of the amount of paper made in Switzerland is obtained from waste paper, for example. Therefore, waste should not be burnt but be prepared so as to save raw materials and energy.

For long, methods and devices for conditioning household waste, industrial waste and similar waste have been known.

Such a method is known from EP 0 243 747 B1. This method is based on a method already existing, but requires less expenditure than that. With this method, in addition to a fraction consisting of magnetic minerals and a fraction consisting of granulates, at least a light-weight fraction of those wastes, which have passed all of the process stages, arises at the end of the process only. However, due to the fact, that the light substances constitute the greatest part of waste, with paper and packing material making about 40% of it, this method requires much expenditure of labor, energy and time, and therefore high working costs.

In order to solve this problem, a method for conditioning household waste, industrial waste and similar wastes is disclosed in EP 0 243 747 B1, wherein the waste is subjected to a pre-shredding process, magnetic grading, sifting, drying and fractionating to gain fibrous and/or granulated materials. Here, the light-weight fraction, which is sifted in an exhausting unit arranged behind the magnetic grader, is subjected to a cutting re-shredding procedure, while the heavy-weight fraction is preferably subjected to granulating re-shredding procedure. Thereafter, both these re-shredded products are fed together again, dried and fractionated into fibrous material and granulated material.

With this method, a special measure is that a first partial stream or the total stream of the light-weight fraction is branched in one of the exhausting channels and/or a second partial stream or the total stream of the light-weight fraction is branched immediately in front of the cutting re-shredding unit. The first partial stream or the total stream is fed to a re-utilization unit immediately or after having been shredded in a second re-shredding unit, while the second partial stream or the total stream is fed to the second re-shredding unit.

The fraction leaving the second re-shredding unit is conveyed to a briquetting or pelletizing press, where it is pressed to briquets and/or pellets. With this method, recovery of energy from the waste and the use thereof for the recycling process are not considered.

A method and a device for conditioning metalliferous components are disclosed in EP 0 479 293 A1. With this method, light ferrous material and heavy ferrous material are selectively removed by means of an overhead magnetic belt and a drum magnet, respectively. The residual material is separated into a lighter fraction and a heavier fraction by means of air sifting. The lighter fraction especially comprising plastic foils, aluminum foils and paper is shredded and conveyed to an aspirator. The aspirator is equipped with two sieves and an air sifter, which enable the fed material to be separated into a plastic fraction, an aluminum fraction and a fraction comprising particles of heavy metals.

The document mentioned above deals with the problem of metalliferous components of waste only. Conditioning of other components of waste and gaining of energy are not considered.

A method for sorting a mixture of plastic materials from a waste mixture and a waste sorting plant are disclosed in EP 1 188 491 A1. This method enables a mixture substantially consisting of plastic materials and small amounts of impurity material to be sorted from waste. At first, a waste fraction comprising at least objects made of plastic material and beverage packs is separated from such a waste mixture. Then, beverage packs are separated from this waste fraction. Finally, a mixture of plastic materials as heavy-weight fraction is separated from the residual amount of this waste fraction by means of a ballistic separator. Furthermore, objects containing metals are separated from this waste fraction, additionally to or separately from the beverage packs, before the residual amount is fed to the ballistic separator.

Also, this document deals with a partial problem of waste disposal only. Gaining of energy is not considered.

Therefore, object of the invention is to realize waste disposal as extensively as possible, with energetic processes taken into consideration.

This object is solved by a method according to claim 1 and by a device according to claim 10.

A substantial aspect of the method according to the invention is that the waste is dried in a predetermined process stage, wherein the energy required for drying is supplied in the shape of waste heat of a turbine which itself serves to generate energy.

However, ash and dust particles obtained with the drying process obstruct the formation of pellets because they reduce the calorific value thereof. According to the invention, the ash particles are removed in a stage following the drying process.

Below, the invention will be described in detail.

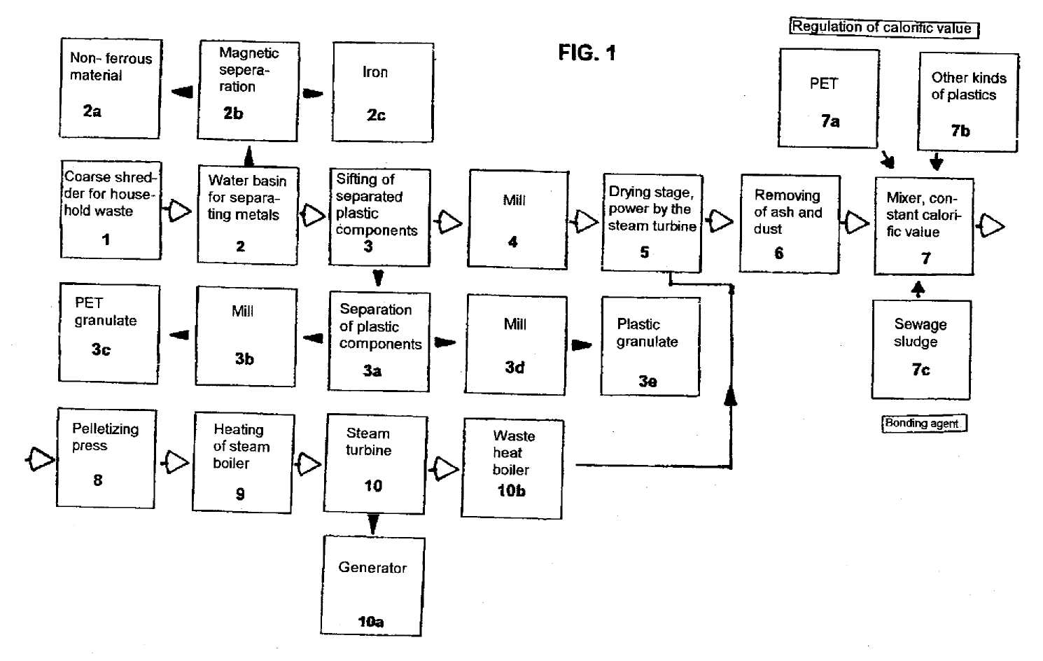

FIG. 1 shows the operating sequence of the method according to the invention,

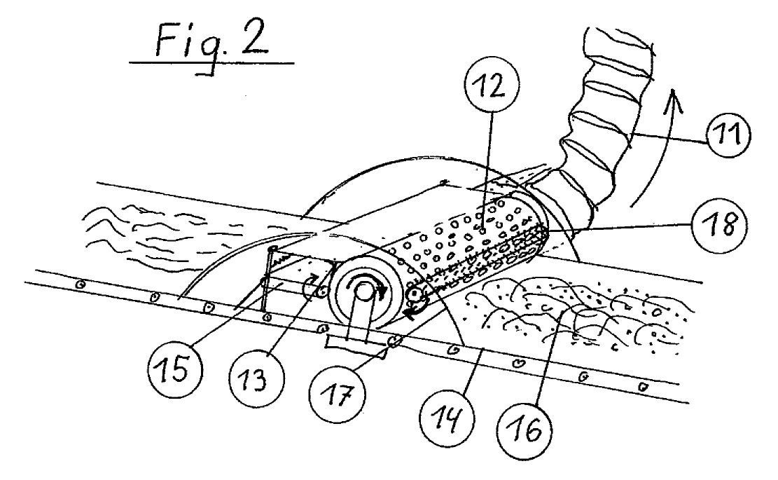

FIG. 2 shows a drying device according to the invention.

As known from the practice, a mixture of waste, which possibly has been subjected to sorting stages already, is put onto a conveyer belt and conveyed by it along sensor and discriminator devices. The sensor and discriminator devices serve to detect characteristic properties of some of the components of this mixture. For example, reflection or absorption of electromagnetic radiation of different frequencies, such as in the X-ray or near infrared range, is used for the determination. It is also possible to determine characteristic properties of components of waste by recognizing colors and shapes thereof optically. When a component of the mixture of waste, which comprises the property wanted, is determined by the sensor and discriminator device, a discharging device is activated so that the identified component is transported by means of pressurized air to a receiving compartment. All of the other components of the mixture of waste, which no characteristic property were attached to, remain on the conveyer belt and are conveyed to a separate receiving compartment for a certain graded fraction.

Below, the principle of the method according to the invention will be described.

In FIG. 1, reference mark 1 denotes the stage in which waste or refuse is put onto a conveyer belt, and reference mark 2 denotes the stage in which waste or refuse is transported into a water basin to separate metalliferous components therefrom. Reference mark 2b denotes the stage in which ferrous metals are separated from nonferrous metals by means of magnets, each of which being transported to a receiving compartment 2c and 2a, respectively.

Then, in stage 3, plastic materials contained in the waste are sifted and separated in a water basin. In the next stage denoted by reference mark 3a, the separated plastic materials are sorted into PET materials (polyethylene terephthalate) and other kinds of plastics. Then, the PET material is fed to a mill 3b, the other kinds of plastics to a mill 3d, where they are ground to granular material. These granular materials are transported to a receiving compartment 3c and 3e, respectively.

The remaining amount of waste is transported to a mill 4 and thereafter, to a drying plant 5 which is mainly operated by waste heat occurring in stage 10b.

In the following processing stages where the remaining amount of waste is pressed to pellets and finally, is burned, it is necessary to remove ash and dust particles occurring with the drying process. As these particles can not be burnt any further, they obstruct the process of gaining energy from the combustible components.

The device for removing ash and dust particles 6 according to claim 10 of the invention is schematically shown in FIG. 2.

In stage 7 of FIG. 1, the granulated PET material denoted by reference mark 7a and the granulated mixture of other plastic materials denoted by reference mark 7b are mixed with sewage sludge denoted by reference mark 7c. This mixture is pressed to pellets in stage 8. In the next stage denoted by reference mark 9, the pellets are burnt in a steam boiler.

The steam produced in the boiler is used to operate a steam turbine denoted by reference mark 10. The steam turbine 10 is coupled to a generator 10a for generating electric energy. Waste heat of the steam turbine 10 is collected in a waste-heat boiler 10b and used for the drying process carried out in stage 5.

In stage 7, mixing is carried out so that the calorific value of pellets, which are used to heat the steam boiler 9, is maintained constant within a predetermined range. This is gained by controlling the amounts of granulated PET material, other plastic materials and sewage sludge.

Now, the most important properties of sewage sludge will be described. Sewage sludge is obtained at several places of a purification plant when waste water is purified. Having a high nutrient content, sewage sludge is used in agriculture for soil improvement. However, sewage sludge also contains great amount of heavy metals so that it may be applied to soils under strict control only. Though, pollution of waste water and also sewage sludge by heavy metals was reduced in the past years, a natural pollution by such metals will always be found. Reduction of the amounts of heavy metals was mainly gained by the development of lead-free petrol and by using the great number of car washing plants where the waste is pre-cleaned by oil separators.

In addition, sewage sludge contains residues of medicaments, diagnostic agents and disinfection agents which can not be decomposed by biological cleaning processes.

Sewage sludge can also be used as fuel because it contains combustible components (organic substances) and ash (inorganic substances). Also having a high content of water (more than 90 percent by weight), it can not directly be used as fuel, but must be dehydrated intensively or dried before being burnt.

Next, PET material will be described in detail.

PET material (polyethylene terephthalate) can simply be called refined mineral oil. Ethylene glycol and terephthalate compounds as liquid initial materials are recovered from mineral oil partly added with oxygen. With this process, the initial compounds are reformed into long chain molecules. Expressed chemically, ethylene glycol and terephthalate compounds are linked with each other by polycondensation. That is, the initial short-chain molecules exclusively consisting of the elements carbon, oxygen and hydrogen are attached to each other by using so-called ester bonds. Plastic material owes its name the terms “poly” (many) and “ester” (kind of bonding). By extending the chains, the material becomes viscous more and more until the wanted consistency is gained at the termination of polycondensation. In principle, PET has been known since 1941, when its base material polyester was developed in the USA. Making of PET for packing material, which must be disposed with waste later on, includes an additional stage of refining the granular material to improve the mechanical properties of final products, among others.

FIG. 2 shows process stage 6 in detail, in which ash and dust particles are removed from waste dried in stage 5.

Reference mark 11 denotes a exhaust hose connected with a exhaust device, and reference mark 12 denotes a exhaust drum. The exhaust drum 12 is a cylindrical rotary body provided with holes or hole-like openings, which is arranged above a conveyer belt 14 transversally to it and is adjustable in height.

In FIG. 2, reference mark 16 denotes waste covered with ash, which is transported from the right side to the left side in this figure.

In parallel with the exhaust drum 12, a stripping device 13 is arranged at one side thereof and a rotary brush 18 for cleaning the exhaust drum is arranged at the other side thereof. The direction of rotation of the exhaust drum 12 is opposite to the direction of course of the conveyer belt 14. The direction of rotation of the rotary brush 18 is opposite to that of the exhaust drum 12.

Reference mark 15 denotes a discharge belt, which is arranged below the stripping device 13 and extends in the same direction as that. The exhaust device is totally covered by a dust protecting shell (17) which ensures that most part of ash is exhausted through the exhaust hose 11. According to the invention, the exhaust stream is pulsed so as to increase the efficiency of the exhaust plant.

### LIST OF REFERENCE SIGNS

(1) Supply of waste (refuse)

(2) Water basin for separating metals (2a, 2b, 2c, nonferrous metals, iron)

(3) Water basin for separating plastic material (3a to 3e, PET and other kinds of plastic material)

(4) Mill

(5) Drying stage

(6) Separating of ash

(7) Mixing stage (components of mixture, 7a, 7b, 7c)

(8) Pelletizing press

(9) Firing of steam boiler

(10) Steam turbine (generator 10a, waste-heat boiler 10b)

(11) Exhaust hose

(12) Exhaust drum

(13) Stripping device

(14) Conveyer belt

(15) Discharge belt for stripping device

(16) Waste covered by ash

(17) Dust protecting shell

(18) Rotary brush

1.-18. (canceled)

19. A waste disposal method, comprising the steps of:
separating metallic components from the waste;
separating minerals+residues and plastic components and separating them as granulates;
drying remaining waste;
removing ash from the dried remaining waste;
mixing ash-free waste with granular plastic material and sewage sludge at an adjustable ratio to produce a mixture;
shaping the mixture into pellets; and
burning the pellets to generate power.

20. The method of claim 19, further comprising the step of using the power generated by burning pellets to dry waste.

21. The method of claim 19, further comprising the step of using the power generated by burning pellets to heat a steam boiler and to operate a steam turbine.

22. The method of claim 21, wherein the steam turbine is provided to operate a generator and the waste heat of the steam turbine is used to dry the waste.

23. The method of claim 19, further comprising the step of separating the plastic components in the form of granulate into PET material and plastic material of other kinds.

24. The method of claim 19, wherein the mixing ratio of ash-free components, plastic components and sewage sludge is used to adjust a calorific value of the pellets.

25. The method of claim 24, wherein the calorific value of pellets is kept constant.

26. The method of claim 19, wherein the sewage sludge is used to adjust a moisture content of the pellets and to hold them together.

27. The method of claim 19, wherein the waste to be disposed is household waste and household-like industrial waste.

28. A waste disposal device, comprising:
a coarse separator and a first water basin for separating metallic components;
a second water basin for separating plastic components and minerals+remaining waste;
a first mill assembly for processing the plastic components into granulate;
a second mill assembly for comminuting the remaining waste;
first means for drying the comminuted remaining waste;
second means for removing ashes from the dried waste;
third means for mixing the ash-free waste with plastic granulate and sewage sludge at an adjustable ratio to produce a mixture;
a press for shaping the mixture into pellets; and
fourth means for burning the pellets to generate power.

29. The device of claim 28, wherein the power generated by the fourth means is used to supply power to the first means.

30. The device of claim 28, wherein the power generated by the fourth means is used to operate a steam boiler and a steam turbine.

31. The device of claim 30, wherein the steam turbine produces waste heat for supply to the first means for drying the comminuted remaining waste

32. The device of claim 28, wherein the first mill assembly is constructed to process the plastic components into PET granulate and granulate of remaining plastic material.

33. The device of claim 28, wherein the separating stage is positioned downstream of the first means and constructed to operate with air stream generated impulsively.

34. The device of claim 28, wherein the third means is constructed to adjust the mixture of ash-free waste, plastic granulate and sewage sludge such as to keep a calorific value of the pellets constant.

35. The device of claim 28, wherein the third means is constructed to adjust the mixture of ash-free waste, plastic granulate and sewage sludge such as to set a moisture content of the pellets and hold them together.

36. The device of claim 28, for disposal of household waste and household-like industrial waste.
